(19) United States
(12) Patent Application Publication
(10) Pub. No.: US 2008/0058482 A1
(43) Pub. Date: Mar. 6, 2008

(54) CONTINUOUS PROCESS POLYMERIZATION OF (METH)ACRYLATE COPOLYMERS

(75) Inventors: Ryan E. Marx, Rosemount, MN (US); James M. Nelson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/468,117

(22) Filed: Aug. 29, 2006

(51) Int. Cl. C08F 2/00

(52) U.S. Cl. 526/64; 526/319

(57) ABSTRACT

Disclosed is a continuous process for the production of copolymers. The copolymers can be made with at least one (meth)acrylate monomer.

### FIELD

The present disclosure relates to a continuous process for the production of a copolymer.

### BACKGROUND

Various types of polymers can be prepared from different monomeric materials, the particular type formed being generally dependent upon the procedures followed in contacting the materials during polymerization. For example, random copolymers can be prepared by the simultaneous reaction of copolymerizable monomers. Block copolymers are formed by sequentially polymerizing different monomers.

Many classes of polymers are synthesized via anionic methods. During anionic polymerization, at least one end of the growing polymer chain is “living”, i.e. provides a site for additional monomers to add onto the polymer chain.

The anionic polymerization process for forming homopolymers and copolymers with well-defined structures can be accomplished with different initiator and catalyst systems as described in U.S. Pat. No. 6,262,204 (Muller et. al.), and EP 1 078 942 (Hamada et. al.).

Synthetic modification of the growing polymer chain ends of a living polymerization can be affected by the addition of reagents or solvents to reduce the reactivity of the polymer chain end and reduce its propensity for side reactions. Typical reagents, such as 1,1-diphenylethylene or α-methylstyrene, are used to reduce the basicity of the polymer chain end as described in Hsieh et al., Anionic Polymerization: Principals and Practical Applications, Ch. 5 and 23, (Marcel Dekker, New York, 1996).

Plug flow reactors may be used with various polymer synthesis methodologies including any step-growth polymerization mechanisms, for example, polycondensations; or chain-growth polymerization mechanisms, for example, anionic, cationic, free-radical, living free radical, coordination, group transfer, metallocene, ring-opening, and the like as described in Odian, G., Principles of Polymerization, 3^{rd} Ed., Wiley-Interscience, 1991, New York, N.Y. The synthesis of homopolymers, random copolymers, block copolymers, star-branched homo-, random, and block copolymers, and end-functionalized polymers is possible by using appropriate polymerization techniques.

### SUMMARY

The present disclosure is directed to a process for making copolymers with controlled molecular weight and narrow polydispersity in a plug flow manner. The reaction mixture comprises an anionically polymerizable monomer, and an initiator, wherein the monomer is polymerized to form a polymer having unmodified polymer chain ends. The unmodified polymer chain ends then further react with a (meth)acrylate monomer in a living polymerization.

In another aspect, the disclosure provides for polar monomers, such as (meth)acrylate monomers, to be polymerized with unmodified polymer chain ends. In this process, the anions of the unmodified polymer chain ends react with the olefinic groups, rather than the ester carbonyl groups of the (meth)acrylate monomers to form a sequential block of the copolymer.

In another aspect, the disclosure provides for a copolymer made in a plug flow manner. The copolymer is derived from anionically polymerizable monomers, and (meth)acrylate monomers sequentially added to unmodified polymer chain ends. The formation of the copolymer occurs as the reaction mixture flows in a plug flow manner in a tubular reactor. The unmodified polymer chain ends of the anionically polymerized monomers, without synthetic modification, further initiate the polymerization of the (meth)acrylate monomers.

Variation in local concentrations of reactants within plug flow reactor or tubular reactor systems typically often leads to greater diversity in products. For example, the products of any given polymerization reaction are a mixture of polymer molecules of different molecular weights related to the length and composition of the individual chains. Living anionic polymerization reactions are very fast and exothermic. Control of initiation and the propagation of polymer chain ends are increasingly difficult, and important to maintain in living polymerization systems. Unfortunately, the polymer chains often tend to grow longer in localities within a plug flow reactor, where the concentration of reactant monomer is relatively higher without efficient temperature and mixing control. The resulting disparity in lengths of the different polymer chains increases the polydispersity index (PDI), a reflection of poor uniformity between individual polymer chains.

Anionic polymerization of temperature sensitive polar monomers, such as (meth)acrylates, via conventional routes, further requires the maintenance of time and temperature conditions to reduce reaction complications caused by the exothermic nature of the reaction. Typically, the anion of a polymer chain end must have reduced reactivity prior to the introduction of polar monomers to reduce potential side reactions during the polymerization to ensure controlled molecular weight and a narrow polydispersity index (PDI).

Conventional techniques to reduce the reactivity of the polymer chain ends include synthetic modification of the growing polymer chain ends of a living polymerization. The addition of reagents or solvents can be used to reduce the reactivity of the polymer chain ends and reduce side reactions. Reagents such as 1,1-diphenylethylene or α-methylstyrene reduce the basicity of the polymer chain ends for subsequent initiation and propagation of temperature sensitive polar monomers.

This disclosure provides a process for making a copolymer, where the polymerization is a living polymerization flowing in a plug flow reactor or tubular reactor. The anionically polymerizable monomers create unmodified polymer chain ends, followed by polymerizing (meth)acrylate monomers to form a copolymer. The process further provides for polymerizing anionically polymerizable monomers, without an intermediate step to modify and/or reduce the basicity of the polymer chain ends, prior to the step of polymerizing the (meth)acrylate monomers. The unmodified polymer chain ends react with the olefin groups of the (meth)acrylate monomers over the ester carbonyl groups of the monomer and polymer chains, thus providing controlled molecular weight and maintaining narrow polydispersities.

### BRIEF DESCRIPTION OF THE DRAWINGS

FIG. 1 is a schematic representation of an exemplary reaction system useful for carrying out the polymerization process of the present disclosure.

FIG. 2 is a schematic representation of an exemplary reaction apparatus useful for carrying out the polymerization process of the present disclosure.

FIG. 3 is a schematic representation of an exemplary feedblock of the reaction system useful for carrying out the polymerization of the present disclosure.

### DETAILED DESCRIPTION

For the following defined terms, these definitions shall be applied, unless a different definition is given in the claims or elsewhere in the specification

The term “unmodified polymer chain end” of this disclosure is defined as a polymer chain end derived from an initiator plus a monomer, wherein the initiator reacts with the monomer to polymerize the monomer resulting in the formation of a polymer chain, where the polymer chain end does not include the addition of a subsequent moiety, or modification of the polymer chain end. Schematically, the “unmodified polymer chain end” can be further defined as:

A+Z-I---->I-(A)ₙ-A⁻Z⁺

where A is the monomer; Z-I is the initiator; and I-(A)ₙ-A⁻Z⁺ is the unmodified polymer chain end.

The recitation of numerical ranges by endpoints includes all numbers subsumed within that range (e.g., 1 to 5 includes 1, 1.5, 2, 2.75, 3, 3.80, 4, and 5).

Unless otherwise indicated, all numbers expressing quantities or ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, their numerical values set forth in the specific examples are reported as precisely as possible. Any numerical value, however, inherently contains errors necessarily resulting from the standard deviations found in their respective testing measurements.

The method of this disclosure describes making a copolymer with controlled molecular weight and narrow polydispersity in a plug flow manner comprising, in a tubular reactor, polymerizing an anionically polymerizable monomer to form unmodified polymer chain ends, and further reacting the polymer chain ends with at least one (meth)acrylate monomer without synthetically modifying the polymer chain ends in a living anionic polymerization. The method further describes living anionic copolymerization in a stirred tubular reactor with temperature controlled sections.

In a further aspect of this disclosure, “living anionic polymerization” refers to a chain polymerization that proceeds via an anionic mechanism without chain termination or chain transfer. Further discussion of this topic can be found in Anionic Polymerization Principles and Applications, H. L. Hsieh, R. P. Quirk, Marcel Dekker, NY, N.Y., 1996, pages 72-127.

A copolymer of this disclosure is further described, wherein anionically polymerizable monomers are polymerized forming unmodified polymer chain ends, and sequentially polymerizing (meth)acrylate monomers from the polymer chain ends. The copolymerization occurs in a plug flow reactor or tubular reactor having one or more temperature controlled sections.

A copolymer of this disclosure having a formula: I-(A)ₓ-(B)_{y} is described, where I is the initiator, A is an anionically polymerizable monomer, and B is the (meth)acrylate monomer sequentially polymerized by a living anionic polymerization mechanism in a plug flow reactor having one or more temperature controlled sections. The unmodified polymer chain ends of A are unmodified without the addition of a subsequent moiety, thus providing an initiating species for the (meth)acrylate monomer (B). A controlled process for continuously making controlled structure copolymers via anionic polymerization is described. Multi-block copolymers can be contemplated from the disclosure.

In an exemplary embodiment, I is an initiator for polymerizing A as a first block, and B is sequentially polymerized as a second block of the copolymer from the polymer chain ends of A without modification. The unmodified polymer chain ends of A initiate B, and further polymerize B to form a copolymer.

In an exemplary embodiment, no subsequent moiety is added to the polymer chain ends of A prior to initiation, and polymerization of monomer B.

The present disclosure provides for a copolymer with a controlled structure. The process is controlled by a number of factors which include temperature or temperature profile in the reactor, the molar ratio of monomers to initiators, and monomer addition sequence. These factors affect the molecular weight, polydispersity, and structure of the final polymerized organic material, or copolymer.

In another aspect of this disclosure, temperature control, percent solids, rate of monomer addition, and time of mixing in a continuous stirred reactor provide for reproducing the copolymers with a similar molecular weight having a narrower polydispersity index than that obtained without temperature control. In a stirred tubular reactor, the exothermic nature of anionic polymerizations can be controlled, thus reducing the complications of side reactions and solution phenomena commonly often associated with the production of copolymers containing polar monomers.

The average molecular weight of the resultant polymeric material is established by controlling the monomer to initiator ratio. This ratio is established by controlling the respective monomer and initiator flow rates. Narrow molecular weight distributions can be further achieved by controlling the temperature of the reaction mixture. Avoiding high temperatures minimizes unwanted side reactions that can result in polymer chains having differing molecular weight averages.

Polydispersity can be influenced by the reaction kinetics of the reaction mixture and the minimization of side reactions, especially when temperature sensitive monomers are present. Maintaining optimum temperatures in each zone of the reactor can positively influence reaction kinetics. Maintaining optimum temperatures can also positively affect the solution viscosity, and the solubility of the reactants.

The structure of the polymerized copolymer is determined by the sequence of monomer addition(s). Homopolymers are formed when only one monomer is polymerized, and random copolymers are formed when more that one monomer type is introduced simultaneously. Segmented block copolymers are formed when more than one monomer is polymerized, where a first monomer is polymerized to form a first block, and a second monomer is sequentially polymerized from the first block.

In an exemplary embodiment of this disclosure, the anionically polymerizable monomer is polymerized to form a first block having unmodified polymer chain ends, where the polymer chain ends initiate the polymerization of the (meth)acrylate monomers to form a second block of the copolymer.

In an exemplary embodiment of this disclosure, the temperature profile of the reactor can be controllable over time, and that the reaction mixture be impelled in a relatively plug flow manner through a tubular or plug flow reactor. This allows the reaction mixture in the reactor at a given location to be subjected to the same reaction conditions as those encountered by previous and subsequent reaction mixture portions as they pass by the same location.

Maintaining temperature control and movement of the reaction mixture in a substantially plug flow manner are complicated by the exothermic nature of the type of reaction being performed, i.e., anionic polymerizations. The use of anionic polymerization methods for the production of block copolymers containing polar monomers may be complicated by side reactions and solution phenomena. Proper mixing and temperature control promote the ability to reproduce the same materials, such as having a similar average molecular weight, and having a narrower polydispersity index (PDI) than those obtained without proper temperature control. The PDI of the copolymers of this disclosure can be less than 3, more preferably can be less than 2, and most preferably can be less than 1.5.

One suitable plug-flow, temperature-controlled reactor is a plug flow reactor (hereinafter “PFR”) or tubular reactor. In one aspect, the tubular reaction can be a stirred tubular reactor. Any type of reactor, or combination of reactors, in which a reaction mixture can move through in a substantially plug flow manner is also suitable. In an aspect of the disclosure, “plug flow manner” refers to a reactor where the fluid moves in a coherent fashion, and the residence time can be substantially the same for all fluid components. Combinations of PFRs, including combinations with extruders, are also suitable. Regardless of the type of reactor chosen, the temperature or temperature profile of the reactor is suitably controllable to the extent that a plug of the reaction mixture in a particular location within the reaction zone (i.e., the portion of the reaction system where the bulk of polymerization occurs) at time t₁ will have substantially the same temperature, or temperature profile as another plug of the reaction mixture at that same location at some other time t₂. The reaction zone can include more than one temperature-controlled zone of the reactor. PFRs can provide for substantially plug flow movement of the reaction mixture, and can be configured such that good temperature control can be attained, and are therefore useful in getting the average molecular weight of the polymer product to remain close to a target value, i.e., have a narrow polydispersity range.

In one aspect, the term “residence time” refers to the time necessary for a theoretical plug of reaction mixture to pass completely through a reactor.

In a continuous polymerization process of the present disclosure, at least one anionically polymerizable monomer, and an initiator are present in the reaction mixture. The function of the initiator is to generate anions in the presence of an anionically polymerizable monomer, which further polymerizes, and forms unmodified polymer chain ends. The polymer chain ends, without synthetic modification, react with the (meth)acrylate monomers to form a second block of a copolymer in a living polymerization.

Anionically-polymerizable monomers are those that generally have a terminal unsaturated carbon-carbon bond. Examples include styrenics, dienes (e.g., aliphatic dienes, cycloaliphatic dienes, and combinations thereof), [n]metallocenophanes, and combinations thereof, as well as anionically-polymerizable polar monomers. Suitable vinyl aromatic monomers further include, but are not limited to, for example, styrene, p-methylstyrene, methyl-3-styrene, ethyl-4-styrene, dimethyl-3,4-styrene, trimethyl-2,4,6-trimethylstyrene, tert-butyl-3-styrene, dichloro-2-6-styrene, vinyl naphthalene, vinyl anthracene, and combinations thereof. Polymerizable dienes include, but are not limited to, for example, isoprene, isoprene-derivatives, butadiene, 1,3-pentadiene, cyclohexadiene, and combinations thereof.

In an exemplary embodiment of this disclosure, isoprene is an anionically polymerizable monomer for forming the first block of the copolymer with unmodified polymer chain ends.

In an exemplary embodiment of this disclosure, styrene is an anionically polymerizable monomer for forming the first block of the copolymer with unmodified polymer chain ends.

Suitable monomers include those that have multiple reaction sites. For example, some monomers may have at least two anionically-polymerizable sites. Another example is a monomer that has at least one functionality that is not anionically-polymerizable in addition to at least one anionically polymerizable site. Such functionalities are known in the art and include those that are reactive by the following mechanisms: condensation, ring opening, nucleophilic displacement, free radical coupling, photolytic coupling, and hydrosilylation.

Initiators particularly useful with specific monomers are well known in the art. Initiators compatible with the exemplary monomer systems discussed herein are summarized in Hsieh et al., Anionic Polymerization: Principles and Practical Applications, Ch. 5, and 23 (Marcel Dekker, New York, 1996). Typical initiators for anionically polymerizable monomers include alkyl and aryl lithiums. These initiators may include, but are not limited to, for example, n-butyl lithium, sec-butyl lithium, tert-butyl lithium, fluorenyl lithium, naphthyllithium, phenyllithium, p-tolyllithium, and combinations thereof.

In an exemplary embodiment of this disclosure, sec-butyl lithium is an initiator for an anionically polymerizable monomer creating unmodified polymer chain ends.

In an exemplary embodiment, the living copolymerization of (meth)acrylates provides for (meth)acrylate monomers, which are polymerized by the unmodified polymer chain ends of a first block to form the second block of the copolymer. In this disclosure, the reactivity of the unmodified polymer chain ends in a plug flow reactor provides for reduced reactivity prior to the addition of (meth)acrylate monomer. The reduced reactivity of the unmodified polymer chain ends reduces the propensity of the anionic polymer chain end to react with the ester carbonyl group of the (meth)acrylate monomers.

In order to reduce the propensity for side reactions during the anionic polymerization of (meth)acrylates, which offer dual functionalities, typically, the basicity of the initiator or polymer chain end is reduced. The anionically polymerizable monomers are substantially consumed prior to the addition of monomers for the formation of a sequential block of the copolymer. For copolymers having (meth)acrylate monomers as the sequential block of a copolymer, the polymer chain ends are typically reacted with a subsequent moiety or reagent, such as α-methylstyrene or 1,1-diphenylethylene, to reduce the anionic polymer chain end reactivity. Typically, α-methylstyrene, or 1,1-diphenylethylene are added to the polymer chain ends, wherein the reagent lacks the propensity to self propagate or polymerize, thus resulting in a chain end containing from 1 to 2 reagent units prior to the addition of the (meth)acrylate monomer. The moiety can be reacted with the growing polymer chain end prior to the initiation and polymerization of (meth)acrylates.

Anionically-polymerizable polar monomers, such as alkyl(meth)acrylates, alkylfluoro(meth)acrylates, branched (meth)acrylates, cyclic (meth)acrylates, and aromatic (meth)acrylates are generally temperature sensitive. In one aspect, t-butyl acrylate is an anionically polymerizable polar monomer. These monomers tend to undergo a significant number of side reactions under adiabatic polymerization conditions, where the initial temperature of the reaction mixture is relatively low, typically well below 40° C., and more commonly below 0° C., and even more commonly at −78° C. Temperature sensitive monomers are susceptible to significant side reactions of the living polymer chain ends with reactive sites, such as ester carbonyl groups, with chain transfer, back-biting, and termination occurring on the same, or a different, polymer chain as the reaction temperature rises. Without a temperature-controlled system, the initial temperature typically must be low to avoid having the exothermic reaction result in a temperature so high that it causes significant side reactions. These side reactions generally result in an undesirable broadening of the polydispersity and lack of molecular weight control for the copolymer that is formed.

More specifically, (meth)acrylate polar monomers include, but are not limited to, for example, tert-butyl(meth)acrylate, methyl(meth)acrylate, isodecyl(meth)acrylate, n-C₁₂H₂₅ (meth)acrylate, n-C₁₈H₃₇(meth)acrylate, allyl(meth)acrylate, 2-ethylhexyl(meth)acrylate, isostearyl(meth)acrylate, isobornyl(meth)acrylate, cyclohexyl(meth)acrylate, phenoxyethyl (meth)acrylate, benzyl(meth)acrylate, and combinations thereof.

In another embodiment, two or more meth(acrylate) monomers may form a triblock copolymer. In one aspect, a first (meth)acrylate monomer is selected from the group comprising tert-butyl(meth)acrylate, methyl(meth)acrylate, isodecyl(meth)acrylate, n-C₁₂H₂₅ (meth)acrylate, n-C₁₈H₃₇(meth)acrylate, allyl(meth)acrylate, 2-ethylhexyl (meth)acrylate, isostearyl(meth)acrylate, isobornyl(meth)acrylate, cyclohexyl (meth)acrylate, phenoxyethyl(meth)acrylate, and benzyl(meth)acrylate, which can self propagate (e.g., polymerize) with the unmodified polymer chain ends, followed by the addition of a second (meth)acrylate resulting in a A-B-C triblock structure. In a further aspect, a second meth(acrylate) monomer can include monomers such as glycidyl (meth)acrylate, dimethylaminoethyl(meth)acrylate, N-methyl (perfluorobutanesulfonamido)ethyl(meth)acrylate, and combinations thereof, achieving an A-B-(C/D) triblock copolymer structure, wherein C/D is a random copolymer.

In another embodiment, C/D can be a mixture of monomers selected from the group comprising tert-butyl(meth)acrylate, methyl(meth)acrylate, isodecyl(meth)acrylate, n-C₁₂H₂₅ (meth)acrylate, n-C₁₈H₃₇(meth)acrylate, allyl(meth)acrylate, 2-ethylhexyl (meth)acrylate, isostearyl(meth)acrylate, isobornyl(meth)acrylate, cyclohexyl (meth)acrylate, phenoxyethyl(meth)acrylate, benzyl(meth)acrylate, glycidyl(meth)acrylate, dimethylaminoethyl(meth)acrylate, and N-methyl(perfluorobutanesulfonamido)ethyl (meth)acrylate.

In an exemplary embodiment of this disclosure, methyl(meth)acrylate is polymerized with the unmodified polymer chain ends of the first block of the copolymer.

In an exemplary embodiment of this disclosure, t-butyl(meth)acrylate is polymerized with the unmodified polymer chain ends of the first block of the copolymer.

Controlled architecture polymer structures formed by the process of the present disclosure include those made with temperature sensitive monomers, resulting in narrow polydispersities at temperatures preferably between −78° C. and 250° C., more preferably −40° C. to +120° C., and most preferably, between −40° C. and 50° C. Because the present disclosure allows for temperature control of the system in a tubular reactor, the initial temperature of the reaction mixture can be maintained at or near the desired temperature throughout the reaction. The reaction mixture can initially be at room temperature or at another desired temperature instead of starting at a low temperature and ending at a high temperature after the exothermic reaction. Further, in a living polymerization for making a copolymer, factors such as temperature of the sections or zones, percent monomer solids in the reactor, rate of addition of the monomers and initiators to the reactor, and mixing of the reaction components within the PFR need to be considered.

The copolymer of the present disclosure can be formed from temperature sensitive monomers, non-temperature sensitive monomers, or a combination of one or more types of temperature sensitive monomers, and one or more types of non-temperature sensitive monomers. In this disclosure, the temperature sensitive monomers can be sequentially polymerized from the polymer chain ends of a first block, which has not been synthetically modified. The temperature sensitive polar monomers can be anionically polymerized sequentially from the first block of the copolymer.

The ratio of monomer to initiator determines the average molecular weight of the resulting polymer. Because the polymerized monomers of the present disclosure have “living” ends, subsequent monomers may be added, without additional initiators when a block copolymer is being made. In this embodiment, it has been found that unmodified polymer chain ends can be used to sequentially initiate and polymerize a second block of a copolymer, more specifically (meth)acrylate monomers in a tubular reactor.

In an exemplary embodiment of this disclosure, the polymer chain ends of the anionically polymerizable monomers are unmodified.

In another aspect, the anionic initiating species of the unmodified polymer chain ends generates an intermediate species, without modification by 1,1-diphenylethylene or α-methyl styrene, to typically achieve a lower pKₐ, which initiates the (meth)acrylate monomer to form the second block of the copolymer. Other reactive moieties may be considered to lower the pKₐ of the polymer chain end.

The term pKₐ is the negative logarithm of the acid dissociation constant, Kₐ, where pKₐ=−log₁₀Kₐ. Kₐ is obtained from the activity ratio of the conjugate base and the conjugate acid multiplied with the proton activity.

In order to form a copolymer having a subsequent (meth)acrylate containing block, the conjugate acid pKₐ value of the initiating species may be substantially the same or smaller than the pKₐ of the conjugate acids corresponding to the initiating carbanionic polymer chain ends of the anionically polymerizable monomer as described in Quirk, R. P., Applications of Anionic Polymerization Research, ACS Symposium Series #696, 1998, pages 6-19.

The continuous copolymerization of (meth)acrylates of this disclosure can be described with at least one or more controlled temperature zones. Temperature control and flow of the reaction mixture in a plug flow reactor, and subsequent addition of (meth)acrylate monomer is accomplished without synthetic modification, to influence the pKₐ of the carbanionic polymer chain ends of the first block of the copolymer. Controlled molecular weight, and polydispersity of the copolymer can be accomplished with the unmodified initiating species of the polymer chain ends of the first block.

This disclosure provides for the synthesis of, random and blocks copolymers, star-branched random and block copolymers, and end-functionalized polymers via living anionic solution polymerizations. In an additional aspect, tri-block and multiblock copolymers can be synthesized in a living polymerization.

In living systems, polymerization can be initiated by reaction of an anionic source (e.g., initiator), with anionically polymerizable monomers. These reactions are typically highly exothermic and air/moisture sensitive reactions. These reactions may proceed until nearly all of the residual monomer is consumed. Upon nearly complete or complete monomer consumption, the “living” and hence reactive chains may be terminated or treated with the same or other anionically polymerizable monomers at a later point along the reactor profile to form higher average molecular weight polymers. These anionically produced “living” chains can also serve as precursors to a number of different polymer structures.

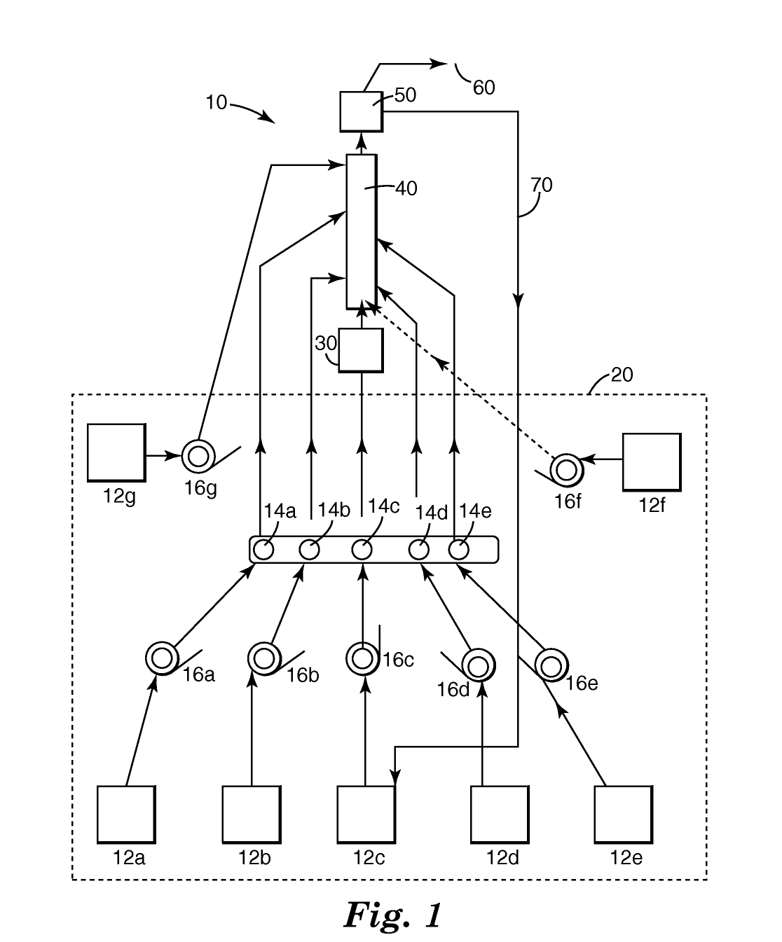

An example of a living system in a plug flow or tubular reactor comprises mixing an alkyl lithium reagent as an anionic initiating source with anionically polymerizable monomers, such as styrene or isoprene, in the first zone of reactor 40 of FIG. 1. The highly exothermic and air/moisture sensitive reaction proceeds when an alkyl lithium reagent and styrene to form a styryl anion. The anion then reacts with additional styrene monomers resulting in the formation of a “living” polystyrene chain, until all residual monomer is consumed. Upon complete monomer consumption, the “living” and hence reactive polystyrene chain may be terminated or treated with further styrene monomer to form a higher average molecular weight homopolymer at a later point along the reactor profile. The “living” polystyryl chains can also serve as precursors to a number of different polymer structures.

In another embodiment of this disclosure, mixing different types of monomers in the first zone of reactor 40 can produce random copolymers, formed by random initiation and propagation of the constituent monomers.

Star or hyperbranched materials can be synthesized by addition of difunctional reagents to living anionic polymerizations. The difunctional monomers can couple polymer chains resulting in branching. Alternatively, living anionically produced chains can be coupled by multifunctional or multisite terminating agents to produce starbranched materials. Suitable difunctional reagents include divinyl benzene (DVB), vinylbenzyl chloride and di(meth)acrylic monomers such as hexanediol di(meth)acrylate (HDDMA), which may be used as comonomers for the production of starbranched materials.

In another embodiment, the reaction mixture comprises a solvent. The function of the solvent is to facilitate mobility of the monomers, initiator, and the polymer produced as well as serving as a partial heat sink.

Solvents compatible with specific monomers are well known in the art. Solvents compatible with the exemplary monomer systems of this disclosure are summarized in Hsieh et al., Anionic Polymerization: Principles and Practical Applications, Ch. 5, and 23 (Marcel Dekker, New York, 1996). One or more solvents can be used as a reaction solvent system. In an exemplary embodiment, the amount of solvent is sufficient to solubilize the reaction components (including additional monomer added downstream) and the resulting product. In an exemplary embodiment, the total monomer concentration in a solvent is from 10 to 80 weight percent. In an exemplary embodiment, the (meth)acrylate monomer concentration ranges from 1 to 50 weight percent. With polar monomers, typical solvents include, but are not limited to, for example, benzene, ethylbenzene, cyclohexane, toluene, tetrahydrofuran and xylene. Co-solvents such as dialkyl ethers, (diethyl ether, dibutyl ether), tetrahydrofuran, or tetramethylene diamine may also be used for both polar and nonpolar monomer systems.

Anionically polymerized polymers can be terminated by adding reagents for terminating a “living” anionic polymerization. Suitable terminating agents include oxygen, water, hydrogen, steam, alcohols, ketones, esters, amines, hindered phenols, and combinations thereof.

Anionic polymerizations are not readily amenable to the polymerization of monomers containing relatively acidic, proton donating groups such as amino, hydroxyl, thiol, carboxyl or acetylene functional groups. Methodologies to include such functional groups typically involve the use of protected terminating agents (A_{fn}), derived by the use of suitable protecting groups that are stable to the conditions of anionic polymerization and can be readily removed by post polymerization treatments. Such suitable terminating agents include, but are not limited to, for example, chloroorganosilyalkenes, chlorosilanes (ClSiMe₂NMe₂, ClSiMe₂OR, ClSiMe₂H), 1,3-bis(trimethylsilyl)carbodiimmide, 1-(3-bromopropyl)-2,2,5,5-tetramethyl-1-aza-2,5-disilacyclopentane, (3-bromopropoxy)-tert-butyldimethylsilane, 2-(3-brompropoxy)tetrahydro-2H-pyran, and combinations thereof.

Protected terminating agents with multiple reactive sites may be used to couple two living polymer chains thereby increasing the average molecular weight. Suitable multifunctional or multisite protected terminating agents include, but are not limited to, for example, dimethyl phthalate, phosphorus trichloride, methyltrichlorsilane, silicon tetrachloride, hexachlorodisilane, and 1,2,3-tris(chloromethyl)benzene, dichlorodimethylsilane, dibromo-p-xylene, dichloro-p-xylene, bischloromethylether, methylene iodide, 1-4-dibromo-2-butene, 4-diiodo-2-butene, and 1,2-dibromoethane.

In another embodiment, the protected terminating agent becomes attached to the polymerizing end of a said chain, and may be multifunctional in nature. The multifunctional terminating agent is capable of terminating multiple chains, thereby producing a star-like macromolecule.

In one aspect of the present disclosure, a continuous process for producing anionically polymerized copolymers having controlled structures, includes, for example, random and block copolymers, star-branched random and block copolymers, and end-functionalized copolymers.

The continuous process for making a copolymer of this disclosure in a plug flow manner of the stirred tubular reactor is described. The reaction mixture flows through the reactor, where the anionically polymerizable monomer reacts with an initiator, followed by polymerization of the monomer to form a first block. Consumption of the monomer yields unmodified polymer chain ends. The unmodified polymer chains ends are used for the subsequent initiation of temperature sensitive polar monomers. The unmodified polymer chain ends initiate the polymerization of at least one (meth)acrylate monomer to form a copolymer.

In one embodiment of this disclosure, as illustrated in FIG. 1, reaction system 10 includes reaction mixture delivery system 20, optional heat exchanger 30, plug flow reactor 40, optional devolatilization mechanism 50, outlet 60, and optional recycle stream 70, which allows residual solvent to be recycled through the system. Reaction mixture delivery system 20 comprises component feed supply units 12a-12g, purification units 14a-e, and pumps 16a-16g. The manner in which these elements are combined and controlled helps to provide, consistently over time, control over the average molecular weight and molecular weight distribution of the polymer produced by the described process. The polydispersities of the resulting polymers can be minimized. Polydispersity indexes of less than 3, preferably less than 2, most preferably less than 1.5 may be achieved (e.g. in a living polymerization). These low polydispersities can be achieved because the reaction system provides good mixing conditions in addition to providing a controlled temperature, which limits side reactions. Monomer to polymer conversions typically greater than 90%, 99% and up to 100% can also be achieved. Accordingly, the resulting polymerized material (solids loading) (e.g. copolymer) is usually comparable to the concentration of the total monomer weight percent loading.

As illustrated in FIG. 1, initially monomer(s) and solvent(s) are impelled from one or more of feed supplies 12a-12e to purification units 14a-14e via pumps 16a-16e and then into reactor 40. In most instances, initiator(s) and terminating agent(s) may be fed directly from feed supplies 12f and 12g, respectively, to reactor 40, for example, by pumps 16f and 16g, without passing through a purification unit 14. Since initiators can be air-sensitive, it may be desirable to feed the initiator directly to the reactor to avoid excess processing that could introduce air into the initiator supply. Terminating agents typically do not need to be purified because the presence of contaminants should not affect their functioning properly. The number of pumps and the configuration of the system, e.g., whether a purification unit is needed, will depend on the number and types of monomers being used. Some components that may be in the reaction mixture such as alkyl lithium reagents, which may be used as initiators, are notoriously sensitive to a variety of deactivating species including, inter alia, H₂O and O₂. Therefore, when sensitive reagents are used, care must be taken to remove or exclude such deactivating species from the monomer(s), solvents, and any additives. Purification units 14a-14e can perform this removal.

As illustrated in FIG. 1, reactor 40 comprises at least one temperature controlled section or zones. Additional sections have individual controlled temperature profiles. In one aspect, the zones of reactor 40 can be maintained at the same, or nearly the same temperature, thus ensuring the reaction mixture encounters a steady temperature profile. The temperatures of each successive section or zone may be maintained at a temperature higher or lower than the previous section, thus ensuring that the reaction mixture encounters a rising or falling temperature profile. The temperature profile may be changed during the course of a reaction by changing the temperature of one or more sections.

In addition to temperature control of the sections or zones, reactor 40 has the capability to impel, from the input end of the reactor 40 to its output end, in a substantially plug flow manner the reaction mixture. The reaction mixture can be impelled through reactor 40 by an external means such as a pressure feed, or by an internal means.

An exemplary embodiment of a continuous stirred tubular reactor is illustrated in FIG. 2. Continuous stirred tubular reactor 100, has a series of cylinders 110 joined together to form substantially tubular reaction chamber 140. First and second shafts 111, 113 are disposed in reaction chamber 140 of stirred tube reactor 100. First and second shafts 111, 113 each extend into reaction chamber 140, and terminate proximal to one another. First shaft 111 extends the entire length of first stirring section 120 and second shaft 113 extends the entire length of second stirring section 130. First and second shafts 111, 113 each outwardly extends from reaction chamber 140 and rotationally engage first and second driving mechanisms 101, 109, respectively.

Referring again to FIG. 2, shown are first and second shafts 111, 113 each having a plurality of paddles 112, 116, respectively, radially extending therefrom. By having two separate driving mechanisms 101, 109, and two shafts 111, 113, this embodiment enables stirring in first stirring region 120 to differ from the stirring in second stirring region 130. This may be favorable where, for instance, the viscosity of a reaction mixture in first stirring region 120 is much lower than the viscosity in second stirring region 130. The cylinders 110 may be joined by flanges 108. Additionally, various types of gaskets may be used to join cylinders 110, in conjunction with or in the alternative to flanges 108. Stirred tube reactor 100 has inlet port 102 and extraction port (e.g. discharging port) 114.

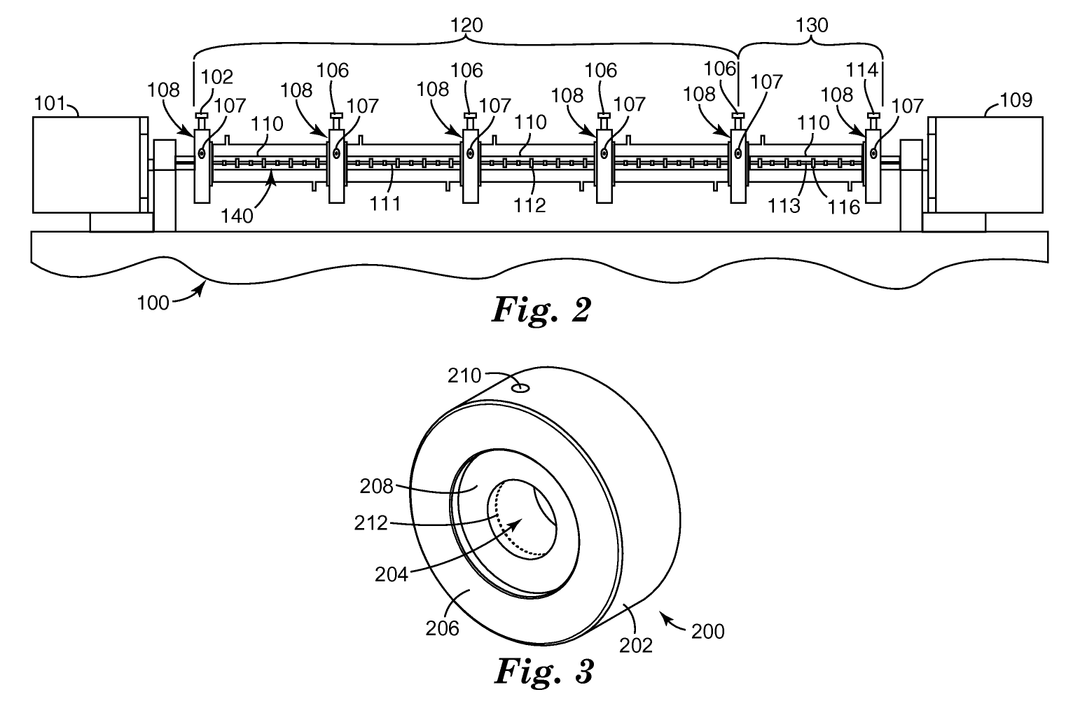

Optionally, any or all of the flanges may be further equipped with a flange inlet port 106, that is in fluid communication with the reaction chamber. A flange inlet port 106 may provide an opportunity to add components to the reaction mixture. The flange may also have an analytical port 107 as an optional port for the removal of an aliquot or reaction mixture for subsequent analysis, other types of monitoring of the reaction mixture at various points in the reaction chamber, or both. In one aspect of this disclosure, the flange inlet port 106 may be designed as to allow for substantial radial mixing with a feedblock of FIG. 3 to deliver reactants to a reaction zone in a tubular reactor. A description of feedblocks can be found in U.S. Pat. Nos. 6,969,490 and 7,022,780, herein incorporated by reference.

In another embodiment of this disclosure, the feedblock 200 as illustrated in FIG. 3 can be aligned to the entry of the temperature-controlled sections 120 and 130.

As illustrated in FIG. 3, feedblock 200 of reactor 100 (FIG. 2) is aligned with the entry of the temperature controlled sections. The feedblock ensures uniform delivery of reactants or other materials into the reaction zones of a plug flow or tubular reactor. The use of a feedblock in a tubular reactor reduces concentration variations, product compositional variability, reactor fouling, and improves radial mixing. Feedblock 200 has a body 202 defining a central opening 204. Body 202 is not necessarily limited to the circular or disc-like shape illustrated in FIG. 3, and alternatively may be modified to have other external profiles. Feedblock 200 has first end 206 with recess 208 for connection to other portions of a PFR. Feedblock 200 similarly has a second end with a recess opposite of the first end 206. Central opening 204 has a cylindrical shape with a circular circumference corresponding generally to the reaction zone of a PFR. Central opening 204 of feedblock 200 may also be referred to as reaction zone 204. Reactants or other fluid materials are delivered into the feedblock 200 at inlet port 210. The reactants subsequently exit body 202 and flow into reaction zone 204 through a plurality of feed ports 212. The feedports 212 are arranged circumferentially about reaction zone 204 in a uniform manner.

In one aspect of the disclosure, purification methods include sparging the monomer(s) with an inert gas (e.g., N₂), and passing the combined stream of the monomer(s) and any solvent to be used in the initiator solutions through one or more purification columns. Such columns are packed with particles that selectively remove dissolved deactivating species. For example, molecular sieves and a variety of desiccants can remove H₂O while activated copper can remove O₂ from fluids coming into contact therewith. Those skilled in the art are aware of the importance of removal of H₂O and O₂ from reaction mixture components as well as numerous ways of accomplishing the same. Low water and oxygen concentrations, i.e., below 10 ppm, ensure that very little initiator or “living” polymer chain is deactivated. Polymerization inhibitors may be removed from monomers by treatment with basic alumina (Al₂O₃) chromatographic materials, as is known in the art. Initiator(s), monomer(s), and solvent(s) are then mixed at the inlet of reactor 40, or are introduced through separate inlets and mixed at some point downstream from the inlet end of reactor 40.

In one embodiment illustrated in FIG. 1, the reaction mixture components (typically monomer(s), and initiator(s)) are impelled from component feed supply units, e.g., 12b, 12c, and 12d for the monomers and 12f for the initiator by pumps 16b, 16c, 16d, and 16f, respectively. Other monomers, solvents, branching agents, protected terminating agent (A_{fn}), terminating agent (Aₙ) and solvents can be added to the reactor 40 at some point further downstream from where the initial charge of monomers. For example, solvents and monomers may be added from component feed supply units 12a and 12e via pumps 16a and 16e, respectively. The feed supplies will pass through a corresponding purification unit 14, if present in the system.

In an embodiment, a branching agent can be a multifunctional anionically polymerizable monomer or multifunctional terminating or coupling agent, where the addition of monomer results in the formation of a star-branched polymer.

Although a pressure feed (i.e., a pressurized tank with a control valve) can be used for each component, the components typically are impelled by pump mechanisms, though this is not essential. A wide variety of pump designs can be useful in the present disclosure as long as the pump seal is sufficient to exclude oxygen, water, and other initiator deactivating materials from feed supply units 12a-12g. Examples of potentially useful pumps include gear pumps, diaphragm pumps, centrifugal pumps, piston pumps, and peristaltic pumps. Selection of a suitable pump for a particular system is within the knowledge of one or ordinary skill in the art.

Some initiator systems are delivered to reactor 40 in the form of a slurry, i.e., a suspension of small particles in a solvent. For example, s-butyl lithium can be mixed in cyclohexane for use with diene and vinyl aromatic monomers. Such slurry initiator systems can settle in feed supply unit 12f and in pump 16f unless care is taken. A mechanism to keep the initiator system well mixed in feed supply unit 12f can be used. Examples of such mechanisms include multiple agitator blades and a pump-around loop. Additionally, such initiator systems can be impelled to reactor 40 by a pump 16f, that can easily handle slurries. Examples of suitable pumps include peristaltic and diaphragm pumps. Tubing used to transport the reaction mixture components to reactor 40 from 12a-g must be capable of handling high pressure and of substantially excluding materials capable of deactivating the initiator being used, e.g., water and oxygen. Useful tubing materials include stainless steel, polypropylene, polyethylene, and polytetrafluoroethylene. When a peristaltic pump is used as one of pumps 16a-16g, the tubing can be a fluoroelastomer.

In an exemplary embodiment, the rate at which pumps 16a-16g impel the reaction mixture components to reactor 40 illustrated in FIG. 1 can be adjusted so the residence time of the reaction mixture in reactor 40 is at or near a desired time. Typical residence times for 1, 10, and 20 Liter (L) PFRs range from 1 minute to 270 minutes, preferably from about 1 minute to about 100 minutes, more preferably from 1 minute to 75 minutes, and most preferably from 3 minutes to 30 minutes. Feed rates and reaction mixture component concentrations can vary with reactor type and degree of polymerization desired.

In one embodiment, the residence time of the copolymer made by the process can range from 30 seconds to 12 minutes per section. The residence times of the reaction mixture and (meth)acrylate monomers can vary as a function of the number of sections and the size of the reactor.

Reactor 40 can be any type of reactor or reactor design that allows for substantially plug flow of a reaction mixture having a total monomer concentration of 10 to 80 weight percent, as well as allowing proper temperature control of the reaction mixture. The reactor can have multiple downstream feed stream injection points. PFRs are further described in U.S. Pat. Nos. 6,448,353; 6,969,491; 6,716,935; 6,969,490; and 7,022,780, herein incorporated by reference.

In a further embodiment of this disclosure, the ability to add reagents at numerous points along the reaction pathway in a PFR makes the PFR well suited for living polymerizations, and functionalizing the end group structure of a polymer. Shorter residence times can result in less waste during changeover (e.g., a change in the type(s) of monomer(s), solvent(s) or initiator(s) being used, the ratio of monomers, the amount(s) of initiator(s), the targeted average molecular weight) and a substantially reduced response time to process condition changes.

In an exemplary embodiment, the reactor has one or more independently temperature controlled zones. A reactor with a single temperature-controlled zone may be used but, if fewer than about two zones are used, the molecular weight and molecular weight distribution of the resulting copolymer tend to be broader than desired. Notwithstanding the foregoing, when the copolymer of this disclosure is being made, the reactor can have at least one independently temperature controlled zone with or without the addition of pre-heaters.

Prior to being used in the process of the present disclosure, reactor 40 may be pretreated. Commonly pretreating is accomplished by filling reactor 40 with a dilute solution of initiator and allowing it to stand for, e.g., about 24 hours. Thereafter, a gaseous sparge and suitable anhydrous solvent can be used to remove the pretreating mixture.

Reaction mixture components can be delivered from purification unit 14 and the initiator feed storage unit 12g to reactor 40 by means of pressure created by pumps 16a-16g. Before reaching reactor 40, the reaction mixture components optionally can pass through heat exchanger 30.

In an embodiment, optional heat exchanger 30 can be used when reactor 40 is to be run at a temperature above or below the temperature of the reaction mixture components prior to being introduced into reactor 40. For example, where the first section of reactor 40 is maintained at or near a temperature of 50° C., the reaction mixture preferably enters the first section of reactor 40 at or near 50° C. Where the reaction mixture components are individually maintained near room temperature (e.g., approximately 25° C.), optional heat exchanger 30 can be a preheater that raises the temperature of the combined reaction mixture components to approximately that of the first section of reactor 40. The monomer may be initially at room temperature or less than room temperature prior to entering the reactor.

Reactor 40 can be surrounded by a jacket containing a circulating heat transfer fluid (e.g., water, steam, liquid nitrogen), which serves as the means to remove heat from or add heat to reactor 40 and the contents thereof. To aid in temperature control, temperature sensing devices (e.g., thermometers and/or thermocouples) can extend into reactor 40 to measure the temperature of the reaction mixture passing thereby. Based on the output of the temperature sensing devices, the temperature and circulation rate of the heat transfer fluid contained in the jacket can be adjusted manually or automatically (e.g., by means of a computer controlled mechanism).

By dividing reactor 40 into sections and individually controlling the temperature of each section, the reaction mixture can be made to encounter a temperature profile. For example, each section of reactor 40 can be maintained at the same (or nearly the same) set temperature, thus ensuring that the reaction mixture encounters a steady temperature profile. This can be accomplished by having separate jackets around each section, or having some other means to independently control the temperature of each section. Cyclic temperature profiles also are possible. Alternatively, each successive section of reactor 40 can be maintained at a temperature higher (or lower) that the previous section, thus ensuring that the reaction mixture encounters a rising (or falling) temperature profile.

The temperatures at which the zones are maintained will depend on the materials being used and the reaction desired, but in general, the system can be operated at temperatures between −78° C. and 250° C., more preferably −40° C. to +120° C., and most preferably, between −40° C. and 50° C. In one aspect, the temperature zones of the system can be operated from −78° C. to 60° C. when used with polar monomers. For a given reaction, the temperature of the reaction mixture can be usually maintained within a range narrower than these operating ranges. The objective of controlling the temperature of each section can be to ensure that the temperature of the reaction mixture can be at a temperature that can be conducive to the desired reaction and will not promote unwanted side reactions. If a reactor were long enough it can be possible that the reaction mixture temperature could be adequately controlled with a single jacketed zone; however, such a system would be not be particularly efficient.

If desired, during the course of an ongoing polymerization, the temperature profile can be changed by changing the temperature of one or more of the sections. Changing the temperature profile can be one way to affect the molecular weight distribution of an organic material for which the polymerization behavior of the monomers can be altered by temperature. Such monomers include (meth)acrylates as described herein. For example, when a reaction is exothermic, side reactions result in polymers with varying molecular weights which can be limited by controlling the temperature of the reaction mixture. Typically, the temperature of the reaction mixture will increase whenever monomer is added and polymerization takes place. Therefore, an exothermic reaction may occur when a first monomer is initially fed into the reactor. Another exothermic reaction may occur downstream when a second monomer is added after the first monomer is partially or fully converted and the mixture may have cooled from the initial reaction.

In an exemplary embodiment, the temperature of the temperature controlled section for polymerizing the (meth)acrylate monomer is lower than the section for polymerizing the anionically polymerizable monomer.

In addition to temperature control, another feature of reactor 40 is the capability to impel, from the input end of reactor 40 to its output end, in a substantially plug flow manner, the reaction mixture contained therein. This means that a given segment of a reaction mixture continues down the length of reactor 40 with about the same velocity profile as a segment traveling there through either earlier or later. The manner in which a reaction mixture can be impelled through reactor 40 can be by an external means such as a pressure feed (e.g., a pump) or by an internal means (e.g., a screw in an extruder). Plug flow can be assisted by lateral mixing means (e.g., radial paddles in a PFR).

In one aspect, the reaction mixture has a total monomers (anionically polymerizable monomer(s) and (meth)acrylate monomer(s)) concentration of 10 to 80 weight percent, and more typically has a concentration of 25 to 60 weight percent. These concentrations allow the reaction mixture to be more easily impelled downstream as polymer forms and increase the viscosity of the reaction mixture.

In an embodiment, reactor 40 can be a stirred tubular reactor (PFR), which may consist of a series of cylinders joined together to form a tube as illustrated in FIG. 2. Down the center of this tube, the PFR may have a shaft having a plurality of paddles radiating therefrom extends along the primary axis of the tube. (Each cylinder can be jacketed as described previously.) As an external drive causes the shaft to rotate, the paddles stir the reaction mixture and assist in heat transfer. In addition, the paddles can be designed such that they assist the pumps and/or pressure head feed systems in propelling the reaction mixture through the tube. The design of PFRs is known to those of skill in the art. The tube can have a volume ranging from a fraction of a liter to several hundred liters or more depending on the number and radii of the cylinders used. The cylinders can be made of glass, tempered glass, various stainless steels, glass-lined steel, or any other material nonreactive with a reaction mixture passing there through, can exclude potential initiator deactivating materials (e.g., atmospheric O₂ and H₂O) from the interior reaction zone, can transfer heat, and can withstand elevated pressure. In an exemplary embodiment, materials include 316 L stainless steel and low coefficient of expansion-type glass (e.g., PYREX glass; Corning Glass Works; Corning, N.Y.). The cylinders can be joined by means of various types of gaskets and flanges. Although the tube can be horizontal or angled, it can be angled upward from its input end to its output end so as to ensure that any inert gas in the PFR can escape through the outlet.

The shaft can be made from a variety of inert metals, one example being stainless steel. Where a corrosive initiator such as alkyllithium can be used in the PFR, the shaft can be made from a corrosion resistant stainless steel (e.g., 316 L stainless steel).

Where the shaft can be hollow, it can be cooled (if desired). This can be accomplished by running a heat transfer fluid, such as water, through it.

To assist in maintaining substantially plug flow through a PFR, the paddles can be designed so as to minimize reaction mixture build-up on the paddles and shaft. Build-up often occurs in stagnant regions, which are normally located on the walls of the tube or on the downstream surfaces of paddles, and can result in reduced heat transfer and plugging of the PFR. PFRs are cleaned less frequently than batch reactors (and because long term continuous operation can be desirable), build-up can result in a loss of residence time. Having to rid a PFR of build-up can result in a loss of production time and the introduction of solvents into the PFR can deactivate catalyst during future runs. Build-up and the problems resulting therefrom can be minimized by proper paddle design.

Optimization of paddle design can involve the use of cylindrical and/or streamlined designs as well as providing for narrower wall clearances toward the outer end of the PFR. Use of paddles with flexible tips (e.g., made from an elastomer such as polytetrafluoroethylene) can assist in scraping the walls of the tube. Alternatively, build-up can be minimized by periodically alternating the direction of paddle rotation. Direction can be alternated every few seconds or minutes (or whatever time frame seems to best inhibit build-up with a particular reaction mixture).

Where a gaseous monomer can be used, the PFR tube can be made from a very strong material (e.g., stainless steel) that can withstand the elevated pressure necessary to assure solubility of the gaseous monomer.

PFR s and combinations of PFR s have been mentioned as examples of useful designs for reactor 40. They are meant to be merely illustrative. One skilled in the art will recognize, using the teachings of the present disclosure that, other designs (e.g., those that allow for substantially plug flow and temperature control of a mixture with a total monomer concentration of 10 to 80 weight percent solids) are within the scope of the present disclosure when used as reactor 40.

Where a PFR can be used alone as reactor 40, a terminating agent solution may be added to the reaction mixture soon after it exits reactor 40. This can be accomplished by blending the reaction mixture and terminating agent and protected terminating agent feeds (not shown) through a simple T-pipe arrangement. To ensure thorough mixing of the two feeds, the combined feed can be fed into another mixer (e.g., a static mixer).

Those skilled in the art will recognize that a wide variety of materials can be used to terminate various initiator systems, which include, for example, oxygen, water, steam, alcohols, ketones, esters, amines and hindered phenols.

The polymer and/or the reaction mixture can be to be processed at elevated temperatures (e.g., high temperature devolatilization of the reaction mixture or hot-melt coating of the polymer), with the addition of a thermal stabilizer. A variety of thermal stabilizers, including hindered phenols and phosphites, are widely used in the industry. A stabilizer can be used, where it is soluble in the monomer and polymer; otherwise, a solvent will be necessary as a delivery mechanism.

In the instance where a hindered phenol has been used as the terminating agent, addition of a separate thermal stabilizer may be unnecessary.

Where the polymer product can be to be used in pure form, unreacted monomer can be stripped out of the reaction mixture by optional devolatization mechanism 50. A variety of known devolatilization processes are possible. These include, but are not limited to, vacuum tray drying on, for example, silicone-lined sheets; wiped film and thin film evaporators (when the average molecular weight of the polymer can be not too high); steam stripping; extrusion through a spinneret; and air drying.

In an exemplary embodiment, the devolatilization mechanism 50 can be a DISCOTHERM B high viscosity processor (List AG; Acton, Mass.). Other manufacturers such as Krauss-Maffei Corp. (Florence, Ky.) and Hosokawa-Bepex (Minneapolis, Minn.) make similar processors. These types of processors have been found to be efficient in separating polymer product from the remainder of the terminated reaction mixture. If desired, such processors can be maintained at below ambient pressures so that reduced temperatures can be used. Use of reduced pressures permits the recapture of very volatile components without extensive degradation of the polymer.

The remaining components of the reaction mixture (e.g., solvents, and any terminating agent solution) that were used may be condensed and separated from each other. Commonly, these materials can be removed by means of distillation; e.g., solvents(s) with boiling points that differ significantly from those of the terminating agent. Recycled solvent passes through purification unit 14 prior to being reintroduced into reactor 40.

Once the polymer product has been isolated from the remainder of the reaction mixture, it can be discharged from the reactor 40, and collected directly from outlet 60 in a desired container.

Exemplary embodiments of this disclosure are further illustrated by the following examples. The particular materials and amounts thereof, as well as other conditions and details, recited in these examples should not be used to unduly limit this disclosure.

### EXAMPLES

### Test Methods:

### Molecular Weight and Polydispersity

The average molecular weight and polydispersity of a sample was determined by Gel Permeation Chromatography (GPC) analysis. Approximately 25 mg of a sample was dissolved in 10 milliliters (mL) of tetrahydrofuran (THF) to form a mixture. The mixture was filtered using a 0.2 micron polytetrafluoroethylene (PTFE) syringe filter. Then about 150 microliters (μL) of the filtered solution was injected into a Plgel-Mixed B column (Polymer Laboratories, Amherst, Mass.) that was part of a GPC system also having a Waters® 717 Autosampler and a Waters® 590 Pump (Waters Corporation, Milford, Mass.). The system operated at room temperature, with a THF eluent that moved at a flow rate of approximately 0.95 mL/min. An Erma ERC-7525A Refractive Index Detector (JM Science Inc. Grand Island, N.Y.) was used to detect changes in concentration. Number average molecular weight (Mₙ) and polydispersity index (PDI) calculations were based on a calibration mode that used narrow polydispersity polystyrene controls ranging in molecular weight from 580 g/mole to 7.5×10⁶ g/mole. The actual calculations were made with PL Caliber® software (Polymer Laboratories, Amherst, Mass.).

### Block Concentration

The concentration of different blocks in a block copolymer was determined by Nuclear Magnetic Resonance (NMR) spectroscopy analysis. A sample was dissolved in deuterated chloroform to a concentration of about 10 weight % solids, and placed in a Unity® 500 MHz NMR Spectrometer (Varian Inc., Palo Alto, Calif.). Block concentrations were calculated from relative areas of characteristic block component spectra.

TABLE 1
Materials

| Material | Description |
|---|---|
| Styrene | Aldrich Chemical Co., Milwaukee, WI. |
| t-Butyl (meth)acrylate | Sans Esters Corp., New York, NY. |
| (tBMA) | |
| sec-Butyllithium (s-BuLi) | Aldrich Chemical Co., Milwaukee, WI |
| | (1.4 Molar in cyclohexane) |
| Toluene | Brenntag Great Lakes, St. Paul, MN |
| Cyclohexane | Ashland Chemical, Columbus, OH. |
| Isoprene | Aldrich Chemical Co., Milwaukee, WI. |
| 1,1 Diphenylethylene | Aldrich Chemical Co., Milwaukee, WI. |
| (DPE) | |
| Methyl (meth)acrylate | San Esters Corp., New York, NY |
| (MMA) | |
| Tetrahydrofuran (THF) | Brenntag Great Lakes, St. Paul, MN |

### 1 L PFR Description

The 1 L PFR had a reaction zone capacity of 0.94 L and consisted of five jacketed (shell-in-tube) glass sections (Pyrex® cylinders). The tube had an inner diameter of 3.01 cm and an outer diameter of 3.81 cm. The shell had a diameter of 6.4 cm. All five sections, corresponding to zones 1-5, were 25.4 cm long. The sections were joined together by stainless steel coupling disks. The coupling disks were equipped with individual temperature sensing thermocouples extending into the interior of the cylindrical sections. These thermocouples permitted the temperature of the reaction mixture in each section to be monitored and adjusted up or down (as necessary) to a set point by varying the temperature of the heat transfer fluid flowing through the jacketed sections. The coupling disks also contained various single inlet ports through which monomer or solvent could be added into the reaction mixture.

Extending through the center of the joined cylinders was a stainless steel shaft with a length 154.9 cm and a diameter of 0.95 cm. The shaft was suspended along the cylinder axis by shaft alignment pins. The shaft was split into two sections, one section for the first four zones and the other section for the fifth zone. The second section of the shaft butted into a Teflon plug in the first section of the shaft. This allowed the two sections of the shaft to be stirred at two different rates and two different directions in the same reactor. Thirty detachable stainless steel paddles with approximately 2.1 cm between each paddle were affixed to the shaft. The rectangular paddles were 1.6 mm thick, 1.91 cm wide and 2.54 cm long. Each section contained six paddles. Each end of the shaft was attached to a variable speed, ¼ hp Baldor industrial gear motor. The stir rate from either end could be controlled from 1 rpm to 314 rpm.

Heat transfer was accomplished by attaching recirculators to the jackets. All zones were heated or cooled with water. They were all independently heated or cooled except zones 4 and 5, which were heated or cooled in series from the same recirculator. Zone 1 was heated or cooled in a co-current manner while the other four zones were heated or cooled in a countercurrent fashion.

Temperatures in the reactor were monitored and recorded through use of a thermocouple temperature recorder (OCTTEMP 8-channel recorder, Omega Engineering, Inc. Stamford, Conn.) and accompanying software interfaced with a personal computer. Thermocouples (type J; Omega Engineering, Inc. Stamford, Conn.) were positioned in each of the stainless steel coupling pieces to provide zone batch temperatures during polymerizations.

### 10 L PFR Description

The 10 L stirred tubular reactor (PFR) had a capacity of 10 liters and consisted of five jacketed (shell-in-tube) glass sections (Pyrex cylinders). Each tube section had an outside diameter of 7.62 cm, an inside diameter of 6.99 cm, and a length of 57.2 cm. The jackets had an outside diameter of 11.63 cm, an inside diameter of 10.99 cm, and a length of 52.1 cm. The tube sections were joined together with stainless steel coupling flanges, each 3.18 cm thick. The coupling flanges were equipped with individual temperature sensing thermocouples extending into the interior of the tube sections. These thermocouples permitted the temperature of the reaction mixture in each section to be monitored and adjusted up or down, as necessary, to a set point by varying the temperature of the heat transfer fluid flowing through the jacketed sections. Additionally, this reactor was equipped with a preheater to allow for heating of the inlet raw materials prior to initiation. The coupling flanges also contained various inlet ports through which material could be added into the reaction mixture. The PFR was closed off at both ends with stainless steel flanges.

Extending through the center of the joined cylinders was a 1.27 cm diameter stainless steel shaft suspended along the center of the cylinder axis by three shaft alignment pins extending from each of the coupling flanges. Thirty-eight detachable stainless steel paddles with approximately 4.5 cm between each paddle were attached to the shaft. The rectangular paddles in the first four zones were 0.24 cm thick, 4.5 cm wide and 5.1 cm long. The rectangular paddles in the fifth zone were 0.24 cm thick, 5.1 cm wide and 5.7 cm long. The number of paddles in this configuration was as follows: 7 paddles in Zone 1, 8 paddles in Zone 2, 8 paddles in Zone 3, 8 paddles in Zone 4, and 7 paddles in Zone 5. The shaft was attached to a 2.2 kW variable speed motor.

Temperature control for zones 1 and 2 were controlled with recirculating water pumps. Temperature control for zones 3-5 was maintained using HFE 7100 (3M Company, St. Paul, Minn.) cooling fluid, which recirculated through a ½ inch stainless steel coil immersed in a bath consisting of dry-ice/Isopar L (Exxon Mobil Company, Fairfax, Va.).

### Example 1

### PS-t-BMA

An initiator solution was prepared by mixing 65 g of 1.4 M sec-butyllithium in cyclohexane with 3000 g of oxygen-free cyclohexane. Table 1 lists chemicals used in this disclosure. Styrene monomer was fed at a rate of 16.5 g/min through a 1″ diameter×3′ long packed column of basic alumina oxide followed by a 1″ diameter×3′ long column of 3 Å molecular sieves and into zone 1 of the PFR. Toluene was fed at a rate of 31.0 g/min through two packed columns, 1″ diameter×3′ long, 3 Å molecular sieves and into zone 1. The s-BuLi solution was fed into zone 1 at a feed rate of 5.5 g/min. A color change from clear to red was observed in zone 1 when the initiator solution contacted the monomer, and an exotherm resulted. The reaction temperature was kept at about 100° C. by adjusting the jacket temperature of zone 1 to 80° C. The temperature of the jackets in each of the 5 zones of the PFR was individually maintained at: #1=80° C., #2=70° C., #3=50° C., #4=5° C., and #5=5° C.

The materials flowed through the first four zones, facilitated by stirring paddles along the reaction path. Polymerization of the polystyrene continued to substantially 100% completion by the end of zone 4, thereby forming a “living” polystyrene solution. The t-BMA was fed at a rate of 1.5 g/min through a 1″ diameter×3′ long packed column of basic alumina oxide followed by a 1″ diameter×3′ long packed column of 3 Å molecular sieves and into zone 5. The resulting poly(styrene-t-BMA) block copolymer was terminated with isopropanol and samples were collected for analysis. The total residence time for this reaction was about 15.2 minutes.

GPC and NMR analysis was done on the block copolymer to verify the reaction proceeded to completion. The block copolymer was determined to have a Mₙ=7.3×10⁴ with a polydispersity index of 1.5 and 7.7 mol % t-BMA polymer. NMR determined the polymer to be 99% block copolymer. Neither styrene nor t-BMA monomer was detected.

Additional chromatography was done to confirm that the styrene/t-BMA ratio was constant throughout all polymer chains. This was accomplished by comparing the RI (refractive index) trace (corresponding to both styrene and t-BMA) with the uv 280 nm trace (corresponding to the presence of the styrene ring). If the peaks from both traces overlap and display the same shape, then presumably the styrene and (meth)acrylate are distributed in the same ratio throughout all chain lengths. The shapes were consistent with a constant ratio throughout all polymer chains.

### Example 2

### PI-PMMA

The polymerization for Examples 2a and 2b was done in the same manner as Example 1 except that a poly(isoprene-b-methyl(meth)acrylate) block copolymer was synthesized. An initiator solution was prepared by mixing 225 g of 1.4 M sec-butyllithium in cyclohexane with 3000 g of oxygen-free cyclohexane. Example 2a was polymerized with DPE, while 2b did not use DPE. The feed rates into the reactor as well as reactor feed locations are shown in Table 2. In this example, THF was used as a co-solvent to increase the kinetics of the isoprene polymerization. The jacket temperature profile was #1=60° C., #2=60° C., #3=−70° C., #4=−70° C., and #5=−70° C.

TABLE 2
Reactant feed rates

| | Feed | Example 2a Feed | Example 2b Feed Rate |
|---|---|---|---|
| Feed ID | Location | Rate (g/min) | (g/min) |
| Toluene | Zone 1 | 9.9 | 9.9 |
| s-butyllithium | Zone 1 | 7.0 | 7.0 |
| Isoprene | Zone 1 | 8.9 | 8.9 |
| THF | Zone 1 | 1.3 | 1.3 |
| DPE (4.8 wt % in | Zone 3 | 6.7 | 0.0 |
| toluene) | | | |
| MMA | Zone 4 | 1.6 | 1.6 |

Three samples of Example 2a and three samples of 2b were taken to determine if MMA could be polymerized from living polyisoprene chain ends without the use of DPE. GPC and NMR were performed on the samples and the data is presented in Table 3. The data shows the ability to polymerize block copolymers containing MMA anionically without the use of DPE.

TABLE 3
Example 2 Results

| | | Mn | Mw | | 1,2 PI | 1,4 PI | 3,4 PI | MMA |
|---|---|---|---|---|---|---|---|---|
| Sample | Example | g/mol | g/mol | PDI | mole % | mole % | mole % | mole % |
| 1 | 2a | 1.25E+04 | 2.70E+04 | 2.16 | 6.9% | 36.6% | 49.8% | 6.7% |
| 2 | | 1.28E+04 | 2.95E+04 | 2.31 | 5.6% | 37.8% | 49.8% | 6.8% |
| 3 | | 1.18E+04 | 2.69E+04 | 2.28 | 5.7% | 38.5% | 48.0% | 7.8% |
| 4 | 2b | 1.57E+04 | 4.36E+04 | 2.78 | 6.3% | 37.1% | 46.6% | 10.0% |
| 5 | | 1.57E+04 | 4.11E+04 | 2.62 | 5.7% | 37.5% | 46.9% | 9.9% |
| 6 | | 1.60E+04 | 4.53E+04 | 2.84 | 5.9% | 37.8% | 46.5% | 9.9% |

### Example 3

### PS-tBMA—10 L PFR

The polymerization for Examples 3A and 3B was done in a similar manner as Example 1, except that the 10 L PFR was used rather than the 1 L PFR. An initiator slurry was prepared by 1845 g of 1.4M s-BuLi to 8000 g of oxygen-free cyclohexane. The feed rates into the reactor as well as reactor feed locations are shown in Table 4. Toluene was fed via reciprocating piston pump and all other flows were fed via pressure-feeding through control valves. The total reactor residence time was 7.0 minutes and the polymerization was carried out at 32.7% solids. The preheater and jacket temperature profile was: preheater=40° C. #1=50° C., #2=20° C., #3=−60° C., #4=−60° C., and #5=−60° C.

TABLE 4
Reactant feed rates

| Feed ID | Feed Location | Feed Rate (g/min) |
|---|---|---|
| Toluene | Zone 1 | 850 |
| s-butyllithium | Zone 1 | 13.0 |
| Styrene | Zone 1 | 390 |
| tBMA | Zone 5 | 27.1 |

The samples from Example 3 were taken throughout the course of the experiment. Diblock copolymers were formed throughout the experiment without a chain modifier, such as DPE, and product stability was demonstrated. GPC and NMR data is shown in Table 5.

TABLE 5
Example 3 Results

| | | | Styrene | | tBMA | | | |
|---|---|---|---|---|---|---|---|---|
| | | Styrene | monomer | | monomer | | | |
| | Styrene | % block | wt % | t-BMA | wt % | | | |
| Sample | wt % | (NMR) | (after) | wt % | (after) | Mn | Mw | PDI |
| 3A | 93.6 | 99.8 | 0.0 | 6.4 | 0.0 | 125,000 | 174,000 | 1.40 |
| 3B | 94.7 | 99.9 | 0.0 | 5.3 | 0.0 | 124,000 | 178,000 | 1.44 |

1. A continuous process for making a copolymer comprising:
a) providing a reaction mixture comprising:
i) at least one anionically polymerizable monomer, the anioncally polymerizable monomer being free of (meth)acrylate monomer; and
ii) an initiator;
b) causing the mixture to flow through a tubular reactor;
c) polymerizing the monomer to create a polymer having unmodified polymer chain ends; and
d) polymerizing at least one (meth)acrylate monomer with the unmodified polymer chain ends to form a copolymer.

2. The process of claim 1, wherein the reaction mixture further comprises a solvent.

3. The process of claim 1, wherein the reactor is a stirred tubular reactor.

4. The process of claim 1, wherein the reactor includes at least one temperature controlled section.

5. The process of claim 1, wherein the reactor further comprises a feedblock positioned at the entry of the temperature controlled section.

6. The process of claim 4, wherein the temperature of the temperature controlled section for polymerizing the (meth)acrylate monomer is lower than the section for polymerizing the anionically polymerizable monomer.

7. The process of claim 1, wherein the (meth)acrylate monomer concentration ranges from 1 to 50 weight percent.

8. The process of claim 1, wherein the anionically polymerizable monomers are selected from the group consisting of styrenics, aliphatic dienes, cycloaliphatic dienes, and combinations thereof.

9. The process of claim 1, wherein the initiator is selected from the group consisting of alkyl lithium, aryl lithium, and combinations thereof.

10. The process of claim 2, wherein the solvent is selected from the group consisting of benzene, cyclohexane, toluene, ethylbenzene, tetrahydrofuran, and combinations thereof.

11. The process of claim 1, wherein the (meth)acrylate monomer is selected from the group consisting of alkyl(meth)acrylates, alkylfluoro(meth)acrylates, branched(meth)acrylates, cyclic(meth)acrylates, aromatic(meth)acrylates, and combinations thereof.

12. The process of claim 4, wherein the temperatures of the temperature controlled sections range from −78° C. to 250° C.

13. The process of claim 1, wherein the residence time of the copolymer ranges from 30 seconds to 12 minutes per section.

14. The process of claim 1, further includes terminating the copolymer with a terminating agent prior to discharging the copolymer.

15. The process of claim 14, wherein the terminating agent is a protected terminating agent and the copolymer is end-functionalized by means of the terminating agent.

16. A continuous process for making a copolymer comprising:
a) providing a reaction mixture comprising:
i) at least one anionically polymerizable monomer, the anionically polymerizable monomer selected from the group consisting of styrenics, aliphatic dienes, cycloaliphahic dienes. and combinations thereof; and
ii) an initiator;
b) causing the mixture to flow through a tubular reactor;
c) polymerizing the monomer to create a polymer having unmodified polymer chain ends; and
d) polymerizing at least one (meth)acrylate monomer with the unmodified polymer chain ends to form a copolymer.

17. A continuous process for making a copolymer comprising:
a) providing a reaction mixture comprising:
at least one anionically polymerizable monomer; and
ii) an initiator;
b) causing the mixture to flow through a tubular reactor;
c) polymerizing the monomer to create a polymer having unmodified polymer chain ends, the unmodified polymer chain ends free of 1,1 -diphenylethylene or a- methyistyrene; and
d) polymerizing at least one (meth)acrylate monomer with the unmodified polymer chain ends to form a copolymer.
